(19) United States
(12) Patent Application Publication
(10) Pub. No.: US 2002/0130890 A1
(43) Pub. Date: Sep. 19, 2002

(54) Programmatic fitting algorithm in garment simulations

(76) Inventors: Harry Karatassos, Cranberry Township, PA (US); Alan L. Caudill, Pittsburgh, PA (US)

Correspondence Address: Kent E. Baldauf, Jr., Webb Ziesenheim Logsdon Orkin & Hanson, P.C., 700 Koppers Building, 436 Seventh Avenue, Pittsburgh, PA, 15219-1818, US

(21) Appl. No.: 10/073,433

(22) Filed: Feb. 11, 2002

Related U.S. Application Data
(60) Provisional application No. 60/267,581, filed on Feb. 9, 2001.

(51) Int. Cl. G09G 5/00

(52) U.S. Cl. 345/634

(57) ABSTRACT

A method to programmatically map similar virtual garment panels onto a virtual body generally including the steps of selecting a first virtual garment panel, positioning the first virtual garment panel on an area of the virtual body, selecting a second, similar garment panel, and programmatically mapping the second, similar garment panel onto the first virtual garment panel.

### CROSS-REFERENCE TO RELATED APPLICATION

This application claims the benefit of United States Provisional Patent Application Serial No. 60/267,581, filed Feb. 9, 2001, entitled “Refitting Algorithm in Cloth Simulations.”

### BACKGROUND OF THE INVENTION

1. Field of the Invention

The present invention relates to computerized virtual garment simulation systems and, more particularly, to a method of programmatically fitting differently sized virtual garment panels on a set of virtual bodies.

2. Brief Description of the Prior Art

One common method of creating a virtual garment on a virtual body involves two steps. These steps are independent of any real world analog since it is not possible to use a real world process in a computer process. In the real world, garment panels are cut from cloth and then sewn together. Once the garment is completely constructed it is placed around the body by the wearer. In a simulation environment, it is often the case that the garments are assembled around the body.

The first step in the simulation environment, generally referred to as fitting, involves positioning one or more initially flat virtual garment panels resident in a plane in three-dimensional space, and then positioning the virtual garment panels around and in close proximity to a three-dimensional virtual body At the end of the fitting process, each of the virtual garment panels are no longer all resident in the same plane and each virtual garment panel is likely to be non-planar as well.

The second step of the fitting process utilizes the laws of physics and mathematics to transform the independent virtual garment panels placed around the virtual body into an appropriately connected representation of a real three-dimensional garment which is sewn together around the virtual body.

For example, a virtual garment such as a shirt may include a virtual garment panel representing a left arm, a virtual garment panel representing a right arm, a virtual garment panel representing a shirt front, and a virtual garment representing a shirt back. One of the virtual garment panels is manually positioned in a corresponding location on the virtual body. This process is repeated for the remaining virtual garment panels corresponding to the virtual garment.

To date, the fitting process has been labor intensive because of the manual nature of the operation. In the manual fitting process, each panel must be carefully placed by hand around the body using a three-dimensional manipulation program. The time required for a person experienced in fitting to fit a virtual garment around a body varies with the number of virtual garment panels in the virtual garment. Some virtual garments, such as a simple shirt, may have as few as four virtual garment panels, while a virtual suit jacket may have upwards of twenty virtual garment panels which must all be correctly positioned on the virtual body. An experienced fitter may correctly place as many as one virtual garment panel every five minutes; however, the cost of the process is not linear with respect to the number of virtual garment panels. As the number of virtual garment panels increases, so does the complexity of the fitting task.

The problem of manual fitting is made worse due the fact that each size of each virtual garment must be fitted by hand around each body. For example, a typical virtual garment will come in four sizes: small, medium, large, and extra-large. Rather than taking twenty minutes, as derived above for a simple four panel simulated garment, fitting the simulated garment around a simulated body will be expanded to eighty minutes to fit the sizes of this simulated garment around a single virtual body.

The problem is made even worse because a simulation system must have many virtual bodies. A typical commercial system will have twenty or more virtual bodies. When the fitting process must manually fit all of the sizes of a single virtual garment around even twenty virtual bodies, the time required rises to 20 * 80 minutes=1600 minutes, or 26 Hours and 40 minutes. This means that an experienced fitter can fit slightly less than two of the simplest virtual garments in only four sizes around only twenty bodies in a single work week. This makes the fitting process incredibly expensive.

It should be apparent that an enormous amount of time would have to be invested by a business working with a clothing manufacturer with a myriad of clothing articles to manually fit every size of every corresponding virtual garment in simulated space. Therefore, a need clearly exists for a faster, more efficient method of fitting virtual garment panels onto a virtual body.

### SUMMARY OF THE INVENTION

One purpose of the present invention is to programmatically fit a virtual garment onto a virtual body using a manual fit of another virtual garment on a virtual body. For example, shirts come in several different sizes, but generally have the same types of constituent parts- a front, a back, a right arm, and a left arm. It has been found that once the virtual garment panels of a virtual garment are manually positioned, virtual garment panels of the same or a related type (jackets are related to shirts, etc.) virtual garment can then be programmatically placed around the virtual body using a programmatic process. The sameness or relatedness of the manually and programmatically fitted virtual garments allows for similar virtual garment panels to be related to one another for the purposes of the programmatic process. As defined herein, similar used in reference to virtual garment panels refers to virtual garment panels which form the same portion of a virtual garment. For example, a right sleeve virtual garment panel in one virtual garment would be similar to a right sleeve virtual garment panel in a different virtual garment. Therefore, similar material swatches can be applied to differently sized, computerized body shapes. Moreover, one similar material swatch can be larger, smaller, or the same size than another similar material swatch.

One method to programmatically fit a virtual garment onto a virtual body according to the present invention includes the steps of creating a reference virtual garment and using the reference virtual garment to programmatically fit the virtual garment onto the virtual body. The step of creating the reference virtual garment may be accomplished manually. The reference virtual garment may further include at least one virtual garment panel, wherein the virtual garment panel is preferably used in the step of using the reference virtual garment to programmatically fit the virtual garment onto the virtual body. The multiple virtual garment panels in the reference virtual garment may also be related to a single virtual garment panel in the reference virtual garment.

A system to programmatically map similar virtual garment panels onto a virtual body according to the present invention may include computer means electrically connected to a power source, means to generate a virtual body, means to generate a virtual garment panel that defines a particular portion of a virtual garment, and means to programmatically fit a second, similar virtual garment panel on a virtual body.

In essence, the present invention automates a manual, time-consuming process. Instead of manually fitting n-number of virtual garments onto a virtual body, the present invention reduces the number of manually fitted garments to only one reference virtual garment. Thereafter, similar virtual garments are then automatically constructed using the manually fitted virtual garment, and particularly various virtual garment panels constituting the reference virtual garment, as an initial blueprint or blueprints.

These and other advantages of the present invention will be clarified in the description of the preferred embodiment taken together with the attached drawings in which like reference numerals represent like elements throughout.

### BRIEF DESCRIPTION OF THE DRAWINGS

FIG. 1 is side view of a computer and a display device, with the display device showing a virtual body, a first virtual garment panel, and a second, similar virtual garment panel; and

FIG. 2 is a side view of the first virtual garment panel shown in FIG. 1 positioned on the virtual body.

### DETAILED DESCRIPTION OF THE PREFERRED EMBODIMENT

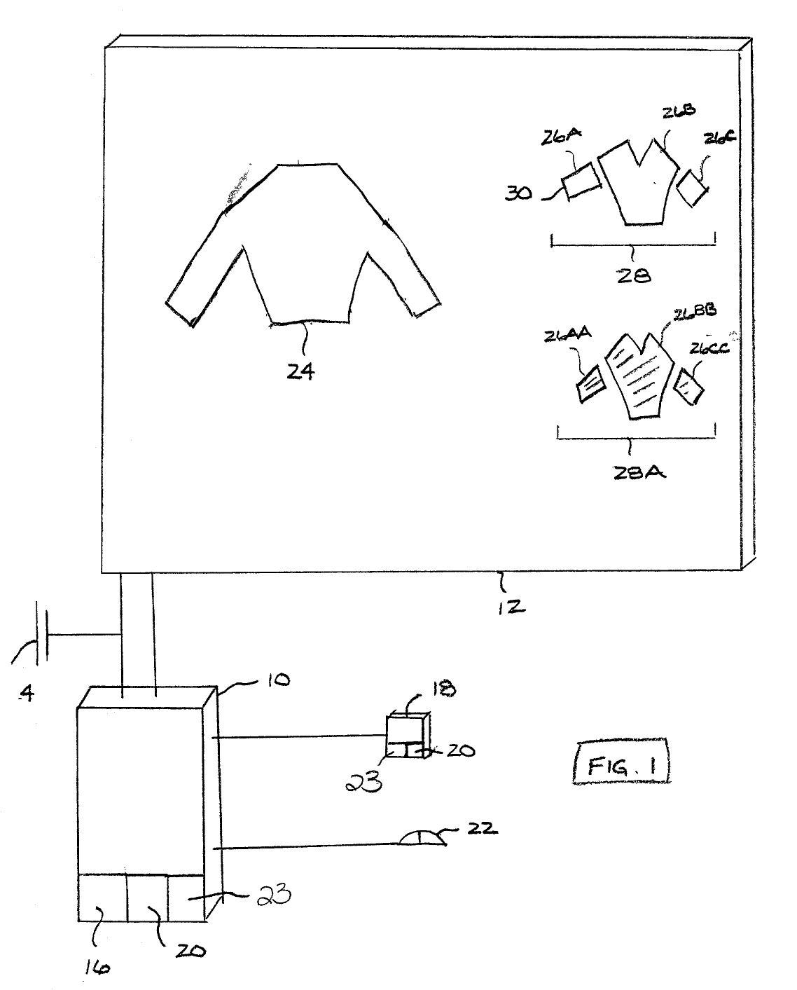

As shown in FIG. 1, the present invention generally includes a computer 10 and a corresponding display device 12, such as a personal computer combination commercially available from DELL, IBM, COMPAQ, or other suitable manufacturer. The computer 10 and corresponding display device 12 are each connected to an electrical source 14. The computer 10 includes a CPU 16, such as those commercially available from INTEL or other suitable manufacturer. The computer 10 is preferable connected to an Internet server 18 for Internet connectivity. A three-dimensional manipulation program, similar to a CAD package, such as 3D STUDIO MAX commercially available from DISCREET, is installed on the computer 10 or server 18 for the manual fitting process. A computer simulation software program 20, such as those commercially available from MAYA or MATHENGINE, is installed on the computer 10 or the server 18. In the preferred embodiment, a proprietary simulation software program is used, though the proprietary simulation software program is similar in function to the other commercially available products. A mouse 22 is also connected to the computer 10.

The virtual body 24 is typically the result of a high quality body scan of an actual human body. A separate computer program, often a garment CAD program, is used to input a wide variety of virtual garment panels 26A-C, 26AA-CC, with each of the virtual garment panels 26A-C, 26AA-CC defining a particular portion of a virtual garment 28, 28A. Also resident in the computer 10 or the server 18 is software 23 according to one aspect of the present invention which programmatically fits differently sized virtual garment panels on a virtual body after an initial manual fit of a reference virtual garment.

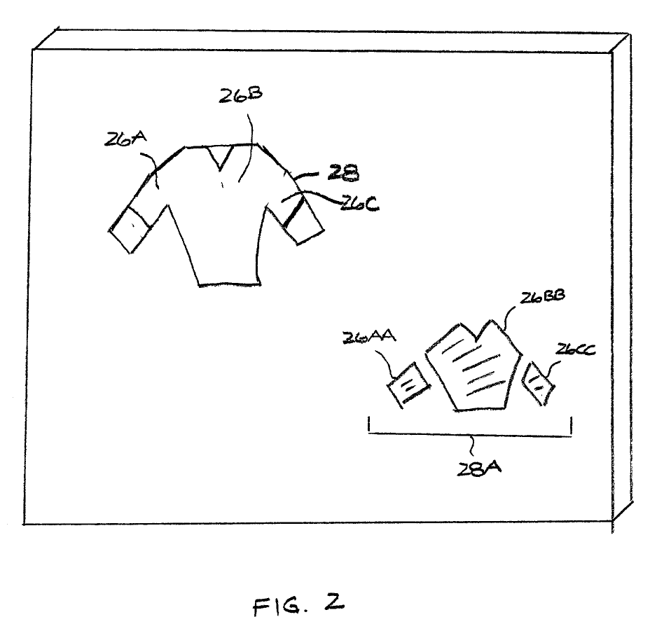

With continuing reference to FIG. 1, one method according to the present invention includes the steps of selecting or creating a first virtual garment panel 30, such as virtual garment panel 26A, and then manually positioning or dragging the selected virtual garment panel 26A adjacent to the virtual body 24. Additional virtual garment panels 26B, 26C, which represent the balance of a computer virtual garment 28, are then individually selected and manually positioned adjacent to the virtual body 24. As shown in FIG. 2, when all of the requisite virtual garment panels 26A-C are manually positioned adjacent to the virtual body 24, the computer simulation modeling software 20 converts the virtual garment panels 26A-C from independent virtual garment panels into an appropriately connected virtual garment 28 which is around the virtual body 24 in three-dimensional space. The manually fitted virtual garment is called a reference virtual garment throughout the remainder of this document for clarity.

The next preferred step is programmatically fitting a second, similar virtual garment around a virtual body 24 using the reference virtual garment as a type of blueprint or pattern. For the clarity and simplicity of this example, a virtual garment is considered similar if it is composed of the same number and type of virtual garment panels; however, there is no reason that the reference virtual garment and subsequent programmatically fitted garment need to be identical in structure. It is wholly reasonable to allow multiple virtual garment panels in the programmatically fitted garment to be related to a single virtual panel in the reference virtual garment. The simplest case would be to use a shirt composed of a front, back, and two sleeves as a reference virtual garment, but programmatically fit a garment which had a front, a back, and two, three-part sleeves so that a colored stripe could be placed in each. Another simple extension encompassed by this invention is reasonable differences in size and shape of the analogous virtual garment panels.

The preferred step of programmatically fitting a second, similar virtual garment around a virtual body 24 using a reference virtual garment includes the following preferred steps. The first sub-step includes identifying a mapping between the virtual garment panels in the reference virtual garment and similar virtual garment panels in the programmatically fitted virtual garment. Second, for each virtual garment panel in the reference virtual garment, iterate through the related virtual garment panels in the programmatically fitted garment, placing each part of the programmatically fitted garment as closely as possible to the appropriate analogous part in the reference virtual garment.

As an example of the programmatic fitting steps just discussed, consider virtual garment panel 26AA shown in FIG. 1. In this case, it is determined that virtual garment panel 26AA is similar to reference virtual garment panel 26A in the reference virtual garment 28A because each of the virtual garment panels 26A, 26AA represent a similar portion of both reference virtual garment 28 and virtual garment 28A. Further, we find that virtual garment panel 26BB is considered similar to 26B and 26CC is considered similar to 26C. Therefore, panel 26AA is programmatically mapped to reference virtual garment panel 26A, panel 26BB is programmatically mapped to panel 26B, and panel 26CC is programmatically mapped to panel 26C.

Programmatically fitting or mapping virtual garments is a substantially complex process. Therefore, the process of programmatically fitting each set of similar virtual garment panels to the analogous virtual garment panel in the reference virtual garment will now be discussed in greater detail. In general, however, programmatic fitting is accomplished using computer software 23 which programmatically fits differently sized virtual garment panels on a virtual body using a provided reference garment which was manually fit. It is best to begin with a general overview of the nature of the virtual garment panels, which includes reference virtual garment panels. A virtual garment panel is defined to be a shape which can be represented as a single closed polygon which is unstressed in a plane. In the real world, garment panels are cut from flat pieces of woven cloth. This constraint in the real world allows one to make this assertion about the ability to represent the virtual garment panel as an unstressed polygon in a plane. This closed planar polygon is very accurate; however, it does not allow for effective simulation. To effectively simulate a virtual garment panel, it is discretized, or divided, into a set of roughly equally sized and adjacent, but not overlapping, polygons. Further, the set of polygons which are output from the discretization process completely cover the original closed polygon. The preferred embodiment uses triangles; however, other implementation of similar systems have used other polygons, including squares. In the preferred embodiment, all triangles which are not on the outside edge of the virtual garment panel will have three adjacent triangles, one on each edge of the triangle. When a programmatic fitting takes place, it is using the discretized representation of the virtual garment panel.

An important feature of virtual garment panels is that they exist in a hybrid five-dimensional space consisting of the following five coordinates: planar x coordinate, planar y coordinate, three space x coordinate, three space y coordinate, and a three space z coordinate. In essence, each virtual garment panel has an immutable planar representation which is as it would be cut from a piece of cloth. This immutable representation gives us the planar x and planar y coordinates. In addition to the immutable representation of the virtual garment panel, there is a mutable three-dimensional representation of the panel which makes simulation possible. The three space x, y, and z coordinates represent the location of the garment when it is placed around the virtual body. As is implicit in the statement that the virtual garment panel exists in a five coordinate space, there is a bijection between the immutable and mutable location representations. For each immutable point, there is also a single mutable point. This is possible because the two and three space representations are identical in polygonal structure and polygonal connectivity.

It is important to note that one of the major strengths of this invention is that the programmatic fitting solution works when the internal discretization of the related virtual garment panels in the reference virtual garment and programmatically fitted garment are not identical. Indeed, it is the expected case that the virtual garment panels from the different garments will be similar in function in the garment, and likely similar in shape; however, the discrete representation is likely to be quite different.

Within programmatic fitting, there are many parts executed using reference virtual garment panels in the reference virtual garment. Part one is to align a set of virtual garment panels to be fit to a similar reference virtual garment panel in the immutable two space representation Part two is to use the reference virtual garment's relationship between the immutable two space coordinate representation and the mutable three space representation to place the mutable three space coordinate of each vertex of each triangle in the programmatically fitted virtual garment into position around the virtual body.

Part one is accomplished by using a directed reference edge in one, or more, of the virtual garment panels in the programmatically fitted virtual garment. For the simplicity of this description, each virtual garment panel to be programmatically fitted must be enclosed by the reference virtual garment panel; however, an extension of this process which removes this restriction is included herein below. There are no constraints that the virtual garment panels will be arranged in such a way that this will occur as the natural output of the garment CAD program or the virtual garment panel discretization step. There are an infinite number of arrangements of the programmatically fitted panels to fit within the reference virtual garment panel; however, only one of them is correct. The reference edge in the reference virtual garment panel is used in conjunction with the reference edges in the programmatically fitted virtual garment panels to rotate the set of panels in the programmatically fitted panel into the correct angular orientation. We know that a single rotation will be sufficient because the panels are arranged in a plane; hence, there is only one axis to rotate around. Once the panels are correctly angularly aligned, a transformation matrix can be composed with a scaling matrix to move the programmatically fitted panels within the reference panel.

Once the programmatically fitted panels are contained within the reference panel and in the same plane, part two is executed. Part two generally involves optimally placing the programmatically fitted panel in three space, using the correct reference virtual garment panel in the reference virtual garment. Since the virtual garment panels are composed of polygons, it is a simple matter to construct a list of all of the unique points in the programmatically fitted virtual garment panel's discrete representation. For each point in the immutable representation of the programmatically fitted virtual garment panel, find the triangle which contains it the immutable representation of the reference virtual garment panel. Such a triangle will exist because the programmatically fitted panel is completely contained within the closed polygonal boundary of the reference panel. Once the containing reference triangle is located, the barycentric coordinate of the programmatically fitted point relative to the reference triangle is computed. The barycentric weights computed against the immutable representation of the reference triangle can then be used against the mutable representation of the reference triangle. Once the barycentric coordinates are converted back to Cartesian three space coordinates, the location of the programmatically fitted panel point is known.

In the simplified algorithmic description herein, it has been generally stated that it is a necessary condition for programmatically fitted virtual garment panels to be completely enclosed by their reference virtual garment panel. As a general rule, however, this limitation is not necessary. For virtual garment panels that are shaped slightly differently, forcing the programmatic virtual garment panel to be completely enclosed in the reference virtual garment panel is unnecessary. An extension to handle this case on incomplete enclosure is to fit the programmatic virtual garment panel mostly inside and use interpolation or extrapolation of the underlying reference virtual garment panel's discretize representation to place non-enclosed points in three space around the virtual body.

The simplified algorithmic description herein is concerned with fitting multiple garments around a single virtual body. In the same way that different virtual garments have common elements, so do different virtual bodies. Identifying multiple virtual body landmarks (left pectoral, right pectoral, crotch, etc.) allows this programmatic fitting process to programmatically fit a virtual garment on a virtual body different from the virtual body used in the manual fitting process to create the reference virtual garment. This extension leads to additional time savings along the axis of the number of virtual bodies, beyond multiple virtual garments and sizes of these virtual garments.

One of the benefits of the present invention is that once a virtual garment is manually positioned on a virtual body, additional similar clothing articles can be quickly and programmatically fitted using a batch operation. The savings in terms of both cost and time are readily apparent since the number of manual fittings is dramatically reduced.

The invention has been described with reference to the preferred embodiment. Obvious modifications and alterations will occur to others upon reading and understanding the preceding detailed description. It is intended that the invention be construed as including all such modifications and alterations insofar as they come within the scope of the appended claims or the equivalents thereof.

We claim:

1. A method to programmatically fit a virtual garment onto a virtual body comprising the steps of:
a) creating a reference virtual garment; and
b) using the reference virtual garment to programmatically fit the virtual garment onto the virtual body.

2. The method as claimed in claim 1, wherein the step of creating the reference virtual garment is accomplished manually.

3. The method as claimed in claim 1, wherein the reference virtual garment further comprises at least one virtual garment panel and the virtual garment panel is used in the step of using the reference virtual garment to programmatically fit the virtual garment onto the virtual body.

4. The method as claimed in claim 3, wherein the multiple virtual garment panels in the reference virtual garment are related to a single virtual garment panel in the reference virtual garment.

5. The method as claimed in claim 1, wherein the step of using the reference virtual garment to programmatically fit the virtual garment onto the virtual body further comprises the step of aligning a set of virtual garment panels to be fit to a similar reference virtual garment panel.

6. The method as claimed in claim 5, wherein each virtual garment panel comprises a plurality of triangles each having vertices and further comprising the step of using a relationship between an immutable two space coordinate representation and a mutable three space representation of the reference virtual garment to place a mutable three space coordinate of each of the vertices of each triangle in the virtual garment into position around the virtual body.

7. A system to programmatically map similar virtual garment panels onto a virtual body comprising:
a) computer means electrically connected to a power source;
b) means to generate a virtual body;
c) means to generate a virtual garment panel that defines a particular portion of a virtual garment; and
d) means to programmatically fit a second, similar virtual garment panel on a virtual body.
